(19) United States
(12) Patent Application Publication
(10) Pub. No.: US 2008/0167942 A1
(43) Pub. Date: Jul. 10, 2008

(54) PERIODIC REVENUE FORECASTING FOR MULTIPLE LEVELS OF AN ENTERPRISE USING DATA FROM MULTIPLE SOURCES

(75) Inventors: Yasuo Amemiya, Hartsdale, NY (US); Jonathan R. M. Hosking, Scarsdale, NY (US); Wanli Min, Mount Kisco, NY (US); Laura Wynter, Chappaqua, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/620,678

(22) Filed: Jan. 7, 2007

(51) Int. Cl. G06Q 10/00; G06F 17/11

(52) U.S. Cl. 705/10; 705/7

(57) ABSTRACT

An embodiment of the present invention proposes to describe an enterprise or company in terms of its structure and represent that structure in performing revenue forecasts for the enterprise or company. Mapping the company structure in a multi-dimensional matrix, for example, can represent that structure. The revenue forecasting method is novel in that forecasts for any level of the enterprise or company make use of data and previous forecasts for that and other elements of the structure. In this way, the method improves upon existing methods by leveraging information contained in some data on other data, and learning the relations between them.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to describing an enterprise or company in terms of its structure and in particular to representing that structure in performing revenue forecasts for the enterprise or company. Mapping the company structure using in a multi-dimensional matrix, for example, can represent that structure. The revenue forecasting method is novel in that forecasts for any level of the enterprise or company make use of data and previous forecasts for that and other elements of the structure. In this way, the method improves upon existing methods by leveraging information contained in some data on other data, and learning the relations between them.

2. Description of Background

Revenue forecasts are typically provided periodically, such as every quarter, to shareholders by public companies. In addition, periodic revenue forecasts are typically used internally in large companies to evaluate, assess, and possibly enact change. In many cases, such change may be desired so that the quarterly or other periodic revenue assessment will be more favorable. As such, revenue forecasts are generally computed at more than one point during the quarter or other period of reference.

Numerous methods exist to perform regular assessments of revenue at multiple periods during a quarter or other period of reference. Some are ad-hoc, and some make use of simple computational techniques. In some cases, more complex techniques are used in practice.

One difficulty with the current state-of-practice is that existing methods for generating multiple assessments of quarterly revenue, or revenue for some other reference period, are seldom done systematically for all levels of an organization. For example, a global company typically uses one method at the highest level of the company, whereas local forecasts at lower levels are done using different approaches. Consequently, it is difficult to compare both sets of estimates, or to validate one or the other. Furthermore, knowledge at the lower level may be lost and not leveraged by the methods used at the different levels.

Another difficulty is that very often the revenue forecasts, which are computed using quantitative data, such as sales data, are fundamentally volatile. For example, if a forecast for the quarter is updated each week using the weekly sales results for that week, it will typically vary considerably from one week to the next, as sales figures change. This is true whether the revenue forecast is updated using sales data or other internal or external company data. Shifts in the data are transferred in these methods to shifts in the assessment of quarterly revenue, making the assessment difficult to use for corrective purposes within the company.

A third difficulty with existing methods is that they often suffer from low accuracy at the lowest levels of the company. Indeed, while forecasts for the highest level of the company (e.g. worldwide), including those that use simple methods, can in many cases be quite accurate, the same does not hold for the lower levels (e.g. regional forecasts). The reason for this is that at the highest levels, errors on the positive side or the true value cancel with those on the negative side of the true value, and the end result in some cases can get close to the true value. At the lower levels of the enterprise, it is more difficult to leverage the positive errors and negative errors, since there are fewer such numbers to use. Hence, it becomes more important to make use of better forecasting methods, including those that apply information from one part of the company, to another.

This invention solves the abovementioned three problems: (i) Providing a systematic way to generate consistent revenue assessments or forecasts across multiple levels of a company, (ii) Reducing volatility associated with using raw data to generate and update periodic revenue forecasts, and (iii) Improving accuracy of the revenue forecasts at the lower levels of the enterprise.

### SUMMARY OF THE INVENTION

The shortcomings of the prior art are overcome and additional advantages are provided through the provision of a method of revenue forecasting, the method comprising: defining a first plurality of levels at which data pertinent to a revenue forecast is collected within an enterprise; defining a second plurality of levels at which the revenue forecast is to be produced from the lowest revenue producing the second plurality of levels opportunity to the highest revenue producing the second plurality of levels opportunity; defining a target period for which to produce the revenue forecast; cleansing a plurality of historical data, the plurality of historical data is used in part to perform the revenue forecast; identifying a plurality of principal factors; defining a plurality of factorial structures for the revenue forecast based on a plurality of statistical techniques; fitting to the plurality of historical data one or more statistical models that relate revenue to classifying factors by way of the plurality of factorial structures; and estimating the revenue forecast for the target period.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which is a revenue forecasting method that forecasts for any level of the enterprise or company. In this way, the method improves upon existing methods by leveraging information contained in some data on other data, and learning the relations between them.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a method of revenue forecasting.

The detailed description explains the preferred embodiments of the invention, together with advantages and features, by way of example with reference to the drawings.

### DETAILED DESCRIPTION OF THE INVENTION

Turning now to the drawings in greater detail, the present invention proposes to describe an enterprise or company in terms of its structure and represent that structure in performing revenue forecasts for the enterprise or company. Mapping the company structure in a multi-dimensional matrix, for example, can represent that structure. The revenue forecasting method is novel in that forecasts for any level of the enterprise or company make use of data and previous forecasts for that and other elements of the structure. In this way, the method improves upon existing methods by leveraging information contained in some data on other data, and learning the relations between them.

In an exemplary embodiment, the present invention takes in multiple data sources from within and outside the company. In particular, it is common to use internal sales data, pipeline, or opportunity, data, historical revenue data, as well as other data when available, such as shipping data, and data external to the company, such as data on the economy or on the financial health of customers of the company.

Typically, data exists at multiple levels of an enterprise. In an exemplary embodiment, the present invention has a particular benefit for large enterprises that operate over wide geographic regions and maintain data at multiple levels, since it enables a consistency in the revenue forecasts that is not usually present otherwise. An example of the multiple levels at which large enterprises operate and maintain data is by geographic region, where some high-level summaries are maintained (such as by continent or other large geographical area) as well as lower-level summaries (e.g. by country, or by region). In addition to the geographical definition of revenue-related data, enterprises often maintain information at different product levels, such as by brand, group, etc, from a high-level description to a finer-grained set of data (e.g. by specific product line versus by some regrouping of several products and/or services).

On the one hand, it is important for revenue forecasts to be consistent across these diverse levels of the company. In addition, it is very useful to make use of correlations and information present in some of the data, for improving the accuracy of the revenue assessments at other levels.

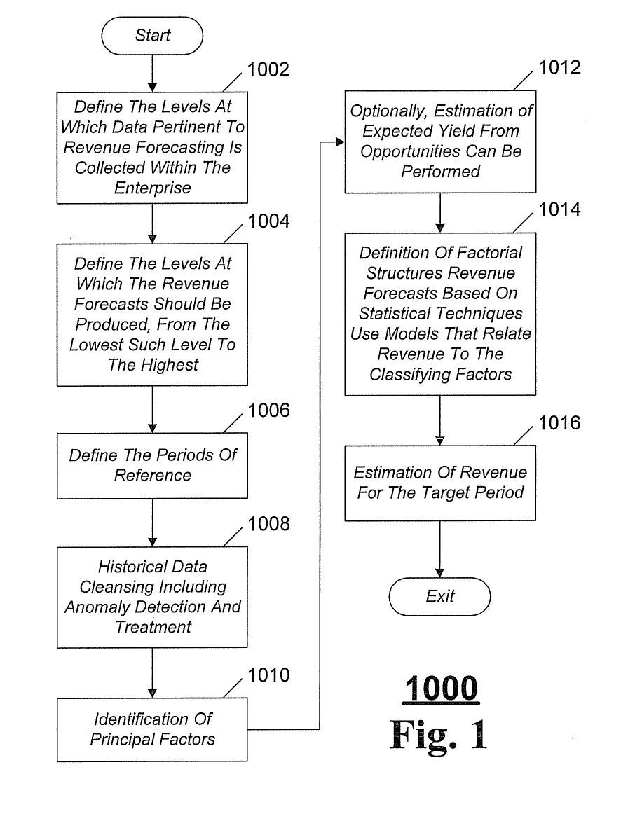

Referring to FIG. 1 there is illustrated a method of revenue forecasting. In an exemplary embodiment the method is novel in that forecasts for any level of the enterprise or company make use of data and previous forecasts for that and other elements of the structure. In this way, the method improves upon existing methods by leveraging information contained in some data on other data, and learning the relations between them. The method begins in block 1002.

In block 1002 levels are defined at which data pertinent to revenue forecasting is collected within the enterprise. Examples of relevant data within the enterprise include: internal sales data, pipeline, or business opportunity data, historical revenue data, shipping data, customer data. Processing then moves to block 1004.

In block 1004 levels are defined at which the revenue forecasts should be produced, from the lowest such level to the highest. Examples include a country-product or region-product, forecast as a low level, and a continent-product-line as a high level. Many other such definitions are possible and should reflect the interests of the management of the enterprise. Processing then moves to block 1006.

In block 1006 periods of reference are defined. The forecast should cover the revenue for some target period, such as a quarter, and should be updated with some frequency, such as weekly, or in some cases monthly or even daily. The target period must be linked to the data in that the data is stated relative to that target period. In many cases, the target period is the quarter. Processing then moves to block 1008.

In block 1008 historical data is cleansed. Anomaly detection and treatment is an important step in the historical data about actual revenues at the different levels. Since the historical data is used to calibrate the models, it is desirable to remove anomalies from this dataset. Processing then moves to block 1010.

In block 1010 principal factors are identified. These are the information sources, other than the historical revenue data itself that will be used to forecast future revenue. Typically, they will include sales and opportunity, or pipeline, data. The data may be divided into opportunities at different levels of maturity, sometimes called sales steps or stages. Then, each stage has its own set of opportunities at each estimation period (such as weekly). Each such stage is also associated then with characteristics of those opportunities at that point or period in time, such as their dollar value. In addition, other characteristics of interest include the product or service, which is included in the opportunity. Data on the financial heath of the client company, or of its sector of the economy, in general, may be included in this step. Processing then moves to block 1012.

In block 1012 optionally an estimation of Expected Yield from opportunities is performed. This step may or may not be included in the method. It involves a more detailed modeling of the opportunities. As mentioned in block 1010, opportunities, or pipeline data, can be aggregated, for example, by the geographical region in which it originated, as well as the product or service types it includes. The sum of the dollar value of those opportunities is an important factor in the revenue forecasting procedure. However, a complementary or alternate approach is to estimate the expected yield from the opportunities, grouped as mentioned above. This can be done by using this step, in which the individual opportunities are modeled, as a function of their attributes; in so doing, a probability can be computed that the opportunity is won. Then, instead of using the stated value of the opportunity as a characteristic, the stated value is multiplied by its probability of being won, thereby providing an expected value for the opportunity. These can be summed in the same way as the original values, as mentioned in block 1010 above. Processing then moves to block 1014.

In block 1014 definition of factorial structures for revenue forecasts based on statistical techniques use models that relate revenue to the classifying factors are determined. These models typically involve parameters that must be estimated at different combinations of the levels of classifying factors. Typically, a parameter defined for a particular combination of levels of classifying factors is estimated using historical data for the same combination of factor levels. E.g., when making forecasts at the region-brand level of aggregation, the forecast for a particular combination of levels, say region ‘R’ and brand ‘B’, may involve estimating the average ratio of actual revenue to firm orders for the combination of region ‘R’ and brand ‘B’, and will typically use historical data for the combination of region ‘R’ and brand ‘B’.

Improved forecasts can often be obtained by using data for related combinations of classifying factors. E.g., forecasts for the combination of region ‘R’ and brand ‘B’ may benefit from the use of data for combinations involving region ‘R’ and other brands, or for combinations involving other regions and brand ‘B’.

In the present approach, information from different combinations of levels of classifying factors is combined by means of a factorial structure analogous to that commonly used in the statistical design of experiments.

E.g. we may model the relation between a parameter alpha defined for combinations of region and brand by the factorial structure:

α_{rb}=β+γᵣ+δ_{b}

where r denotes an arbitrary region and b an arbitrary brand. The parameter would be part of a statistical model relating revenue to the principal factors e.g.

R_{rb}=α_{rb}F_{rb}+e_{rb}

where R_{rb}, F_{rb}, and e_{rb} indicate respectively the revenue, the value of a principal factor, and an error term, all for region r and brand b.

A number of factorial structures are defined: these can be a complete set of all possible structures, a subset of structures that have some maximal degree of complexity, or a set of structures deemed by subject-matter experts to be physically plausible.

Statistical models involving each factorial structure are fitted to historical data. Each model may include terms to take into account the trend or seasonality, such as including the week number, quarter number, etc. In addition to the historical data cleansing of block 1008, this trend-fitting helps to reduce volatility of the forecasts. The best model, according to some suitable criterion, is identified. This “best” model is then used to generate forecasts. Processing then moves to block 1016.

In block 1016 revenue for the target period is estimated. Given the result of optional block 1012 and block 1014, it is in most cases necessary to perform a final estimation, to predict actual revenue from the target period. This is the case, for example, when the estimations in optional block 1012 and block 1014 predict the dollar value of the deals likely to be won in the reference period, rather than the revenue that will actually be accrued during the reference period. Such a scenario occurs frequently. In this case, block 1016 is used to take the predicted sales amounts, at the appropriate levels, and forecast the revenue that will accrue in the reference period from that quantity. Linear regression is an appropriate method for block 1016.

The method can be repeated for a new estimation period, or when new data becomes available, this method can be repeated to provide revised revenue forecasts for the target period. The routine is then exited.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of revenue forecasting, said method comprising:
defining a first plurality of levels at which data pertinent to a revenue forecast is collected within an enterprise;
defining a second plurality of levels at which said revenue forecast is to be produced from the lowest revenue producing said second plurality of levels opportunity to the highest revenue producing said second plurality of levels opportunity;
defining a target period for which to produce said revenue forecast;
cleansing a plurality of historical data, said plurality of historical data is used in part to perform said revenue forecast;
identifying a plurality of principal factors;
defining a plurality of factorial structures for said revenue forecast based on a plurality of statistical techniques;
fitting to said plurality of historical data one or more statistical models that relate revenue to classifying factors by way of said plurality of factorial structures; and
estimating said revenue forecast for said target period.

2. The method in accordance with claim 1, wherein said plurality of principal factors is information sources other than said plurality of historical data.

3. The method in accordance with claim 2, wherein cleansing said plurality of historical data further comprising:
detecting a plurality of anomalies in said plurality of historical data; and
treating as necessary said plurality of anomalies to remove said plurality of anomalies from said plurality of historical data.

4. The method in accordance with claim 3, further comprising:
modeling trend or seasonality to reduce volatility by using week number or quarter number in modeling.

5. The method in accordance with claim 4, further comprising:
estimating expected yield from a plurality of opportunities.

6. The method in accordance with claim 5, further comprising:
repeating said method for a new said target period or when new data becomes available.

7. The method in accordance with claim 6, wherein said plurality of factorial structures include at least one parameter that is derived using parameters from more than one different level of said enterprise.

8. The method in accordance with claim 7, wherein said plurality of factorial structures include:
α_{rb}=β+γᵣ+δ_{b}.

9. The method in accordance with claim 8, wherein said first plurality of levels includes at least one of the following:
internal sales data;
pipeline;
business opportunity data;
historical revenue data;
shipping data; or
customer data.

10. The method in accordance with claim 9, wherein said second plurality of levels includes at least one of the following:
a country-product forecast; or
a continent-product-line.

11. The method in accordance with claim 10, wherein said target period is at least one of the following:
daily;
weekly;
monthly;
quarterly; or
annually.
